(19) United States
(12) Patent Application Publication
(10) Pub. No.: US 2011/0235793 A1
(43) Pub. Date: Sep. 29, 2011

(54) Maximum concurrent event determiner

(76) Inventor: Bryan Love, West Linn, OR (US)

(21) Appl. No.: 13/064,414

(22) Filed: Mar. 23, 2011

Related U.S. Application Data
(60) Provisional application No. 61/282,755, filed on Mar. 26, 2010.

(51) Int. Cl. H04M 15/00

(52) U.S. Cl. 379/133

(57) ABSTRACT

Event records associated with telephone devices are analyzed to calculate a maximum number of concurrent events that occurred during a time period covered by the event records. The begin dates and end dates of the event records to be analyzed are arranged in a specific order, allowing them to be stepped through and compared to each other in a linear fashion. This linear analysis of the event records linearly increases as a number of event records being analyzed increases.

The present application claims priority from U.S. Provisional Application No. 61/282,755, filed Mar. 26, 2010, entitled “MAXIMUM CONCURRENT EVENT DETERMINER”, to Bryan Love, the entirety of which is expressly incorporated herein by reference.

### BACKGROUND OF THE INVENTION

1. Field of the Invention

This invention relates generally to method and apparatus that analyzes and manipulates data. More particularly, it relates to analyzing, manipulating, and determining maximum concurrent events for a particular time from a plurality of telecommunication event records.

2. Background of the Related Art

The telecom industry maintains event records for the many telephone devices that it services. Such telephone device can include a fax machine, a cellular telephone, a smartphone, customer premises equipment, a laptop computer, a desktop computer, etc.

The BEGIN time and the END time for a particular event is recorded. The BEGIN-time and the END-time allows the telecom industry to determine the about of time used by a particular subscriber for billing purposes.

Event records also provide valuable information needed to maintain their telephone network. The telecom industry routinely uses event records stored in a database to calculate the maximum number of concurrent events or sessions, e.g., web sessions, data transfers, Voice over Internet Protocol (VoIP) calls, cellular telephone calls, data transfers, Instant Messaging communications, etc. that occur over a particular time. The time at which the maximum number of concurrent events or sessions occur is also calculated. This information is particularly valuable in determining when a particular service provider needs to increase bandwidth on their network to accommodate large amounts of telecom events. Alternately, the particular carrier can determine if telecom events are concentrated during particular times, allowing the particular carrier to address the added events during those particular times accordingly.

To calculate the maximum number of concurrent events or sessions and the time at which a maximum number of concurrent events or sessions occur, the telecom industry regularly works with data sets having many millions of records. In a data set with n records, the existing solution for finding maximum concurrent events must analyze n² records to find a solution. Doing this ties up valuable resources and has taken in excess of 7 hours in the past to complete.

The time required to find maximum number of concurrent events from a set of data increases exponentially with the size of the data set being analyzed. There is a need for a better system and method to calculate maximum concurrent events and the respective time at which they occur, that scales linearly as a data set that stores telecom event record increases in size.

### SUMMARY OF THE INVENTION

In accordance with the principles of the present invention, a method of calculating concurrent events associated with telephone devices includes accessing a physical event records database to retrieve a plurality of event records associated with a plurality of telephone devices. At least one pointer is set to a beginning of a list of said plurality of event records. The at least one pointer is moved down the list of the plurality of event records to determine a maximum number of concurrent events.

### BRIEF DESCRIPTION OF THE DRAWINGS

Features and advantages of the present invention will become apparent to those skilled in the art from the following description with reference to the drawings:

FIG. 1 shows an exemplary system for storing, accessing and manipulating event records, in accordance with the principles of the present invention.

FIG. 2a shows an exemplary data set for a plurality of event records, in accordance with the principles of the present invention.

FIG. 2b shows the exemplary data set for the plurality of event records from FIG. 2a depicted on a time line, in accordance with the principles of the present invention.

FIG. 3 shows the exemplary data set for the plurality of event records shown in FIG. 2a reordered, in accordance with the principles of the present invention.

FIG. 4 shows an exemplary flow chart for a method of traversing a data set of event records, in accordance with the principles of the present invention.

FIG. 5 shows exemplary numerical results produced by traversing the event records shown in FIG. 3, in accordance with the principles of the present invention.

### DETAILED DESCRIPTION OF ILLUSTRATIVE EMBODIMENTS

The present invent accesses existing event records associated with telephone devices, reorders the ending times for those event records, and traverses the reordered event records to determine the maximum number of concurrent events that occurred during the time period covered by the event records. Additionally, the present invention determines the corresponding earliest and latest ending time for the determined concurrent event records.

By arranging the begin dates and end dates of the records to be analyzed in a specific order, they can be stepped through and compared to each other in a linear fashion. This linear analysis of the event records allows the present invention to significantly reduce the amount of time needed to determine the maximum number of concurrent events that occurred during a plurality of events, and the amount of time needed to determine the earliest and latest ending time for the determined concurrent event records.

Maximum concurrent events can now be calculated on massive data sets quickly and efficiently by traversing the BEGIN times and END times in parallel.

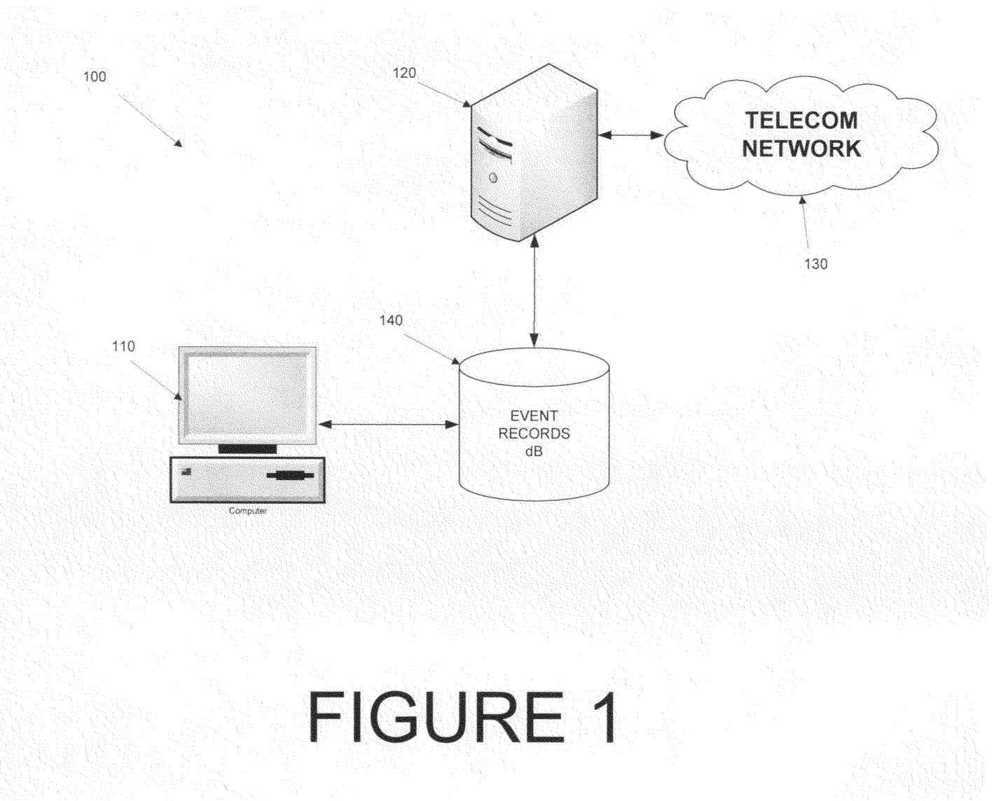

FIG. 1 shows an exemplary system for storing, accessing and manipulating event records, in accordance with the principles of the present invention.

In particular, FIG. 1 shows an event records system 100 that includes an analysis terminal 110, an event records server 120, a telecom network 130, and an event records database 140.

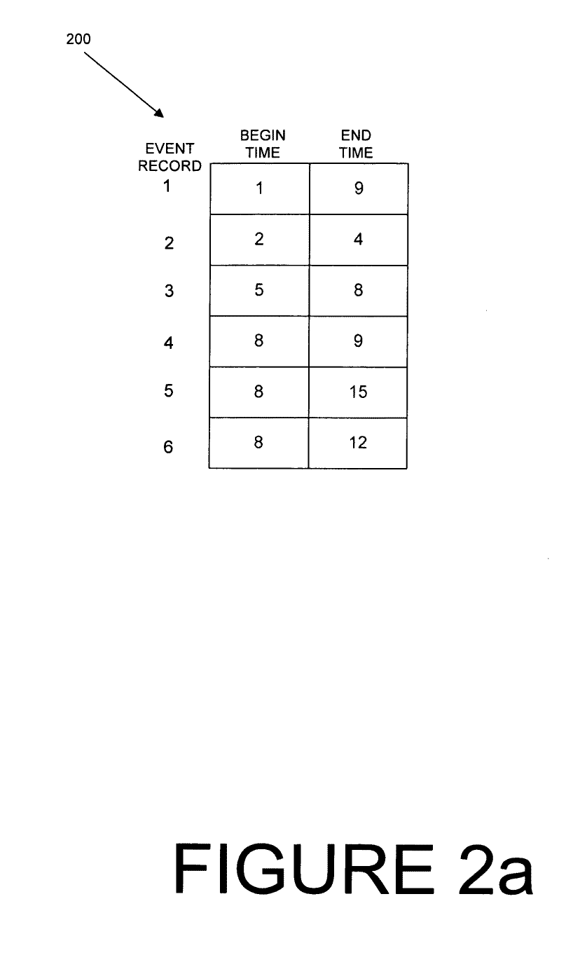

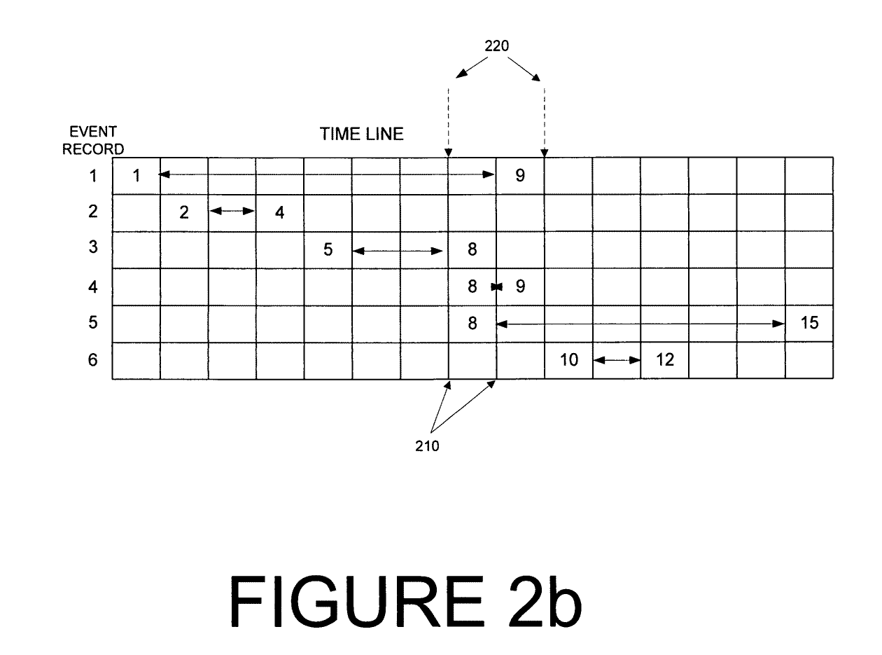

Event records server 120 monitors telecom network 130 for events from which it builds records for such events. The event records server 120 populates the telecom event database 140 with event data. An exemplary data set 200 retrieved from event records database 140 is shown in FIG. 2a.

Once an adequate number of events have been stored in event records database 140, the analysis terminal 110 can access the event records database to retrieve data sets from which the analysis terminal 110 can manipulate the data sets and traverse the data sets to determine the maximum number of concurrent events that occurred for a plurality of events, and the earliest and latest ending time for the determined concurrent event records, as disclosed herein. Manipulation and traversal of an exemplary data set is shown in more detail in FIGS. 2-5.

FIG. 2a shows an exemplary data set for a plurality of event records, in accordance with the principles of the present invention.

In particular, data set 200 is shown to include six events traversing a time period beginning at “1” and ending at “15”. The times are depicted as whole numbers for simplification of understanding. Actual event records include times depicted as hours, minutes, seconds, etc. that can be converted to whole number representations and fractions thereof to simplify calculates.

As shown in FIG. 2a, event record 1 spans a time period beginning at “1” and ending at “9”. Event record 2 spans a time period beginning at “2” and ending at “4”. Event record 3 spans a time period beginning at “5” and ending at “8”. Event record 4 spans a time period beginning at “8” and ending at “9”. Event record 5 spans a time period beginning at “8” and ending at “15”. Event record 6 spans a time period beginning at “10” and ending at “12”.

The maximum number of event records occur during the time period 210 spanning between time “8” and “9”. As can be seen, event records 1, 3, 4 and 5 concurrently occur at a time “8”. Thus, the maximum number of concurrent event records for the data set shown in FIG. 2a is four, with all four commonly occurring at a time of “8”.

The BEGIN times of all events for a data set are sorted in ascending order into a BEGIN-list. Preferably, for maximum benefit the BEGIN times data is pre-sorted. Pre-sorting requires an index on the time fields for the event records stored in event records database 140. For simplification, data set 200 is shown to include pre-sorted BEGIN times.

FIG. 2b shows the exemplary data set for the plurality of event records from FIG. 2a depicted on a time line, in accordance with the principles of the present invention.

To simplify understanding, the data set from FIG. 2a is depicted on a time line. Dashed lines 220 assist in viewing the time period in which the maximum number of events occur during the time period beginning at “1” and ending at “15”. As shown, event records 1, 3, 4 and 5 fall within the time period between “8” and “9”, which represent the maximum number of concurrent events that occur during the time period beginning at “1” and ending at “15”. Additionally, the earliest time and the latest time at which the maximum number events occur is a time of “8” at which all four event records 1, 3, 4 and 5 are active.

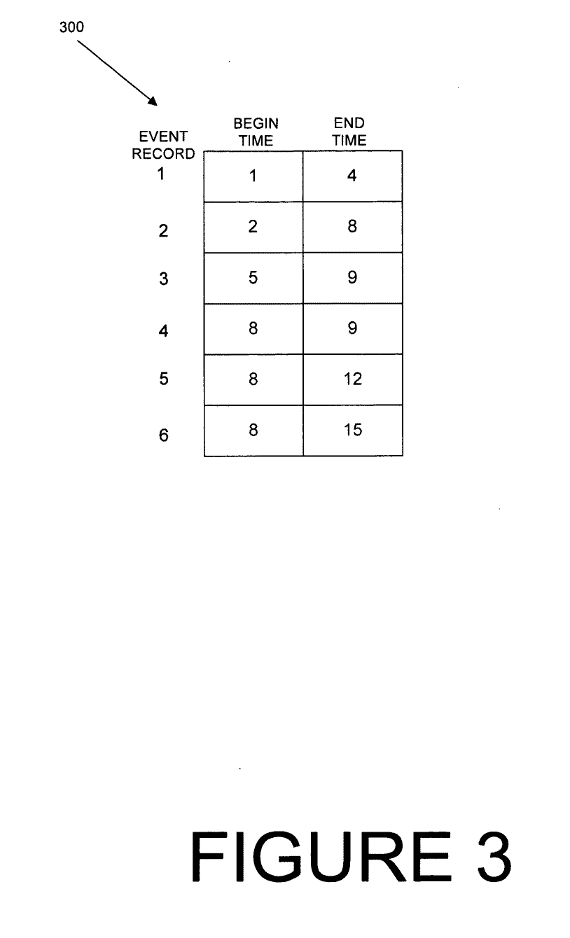

FIG. 3 shows the exemplary data set for the plurality of event records shown in FIG. 2a reordered, in accordance with the principles of the present invention.

The END times are independently sorted in ascending order into an END-list. The resultant ordered data set that includes ascending ordered BEGIN-list and ascending ordered END-list is shown in FIG. 3 as data set 300. The END times can be similarly pre-sorted and indexed on time fields for the event records stored in the event records database 140.

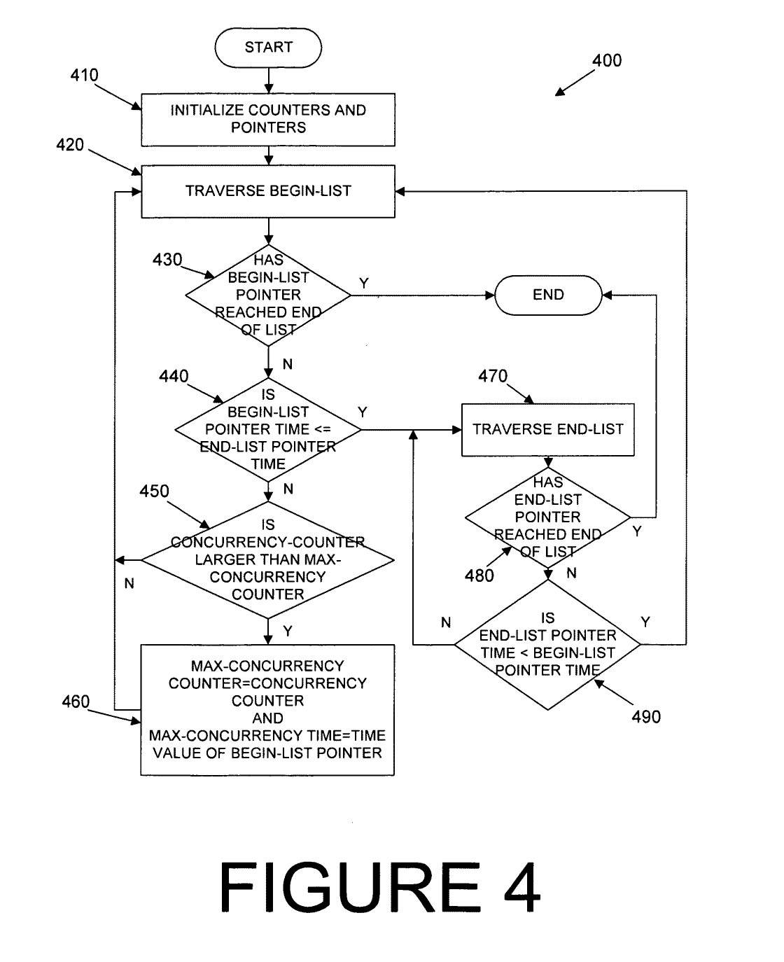

FIG. 4 shows an exemplary flow chart for a method of traversing a data set of event records, in accordance with the principles of the present invention.

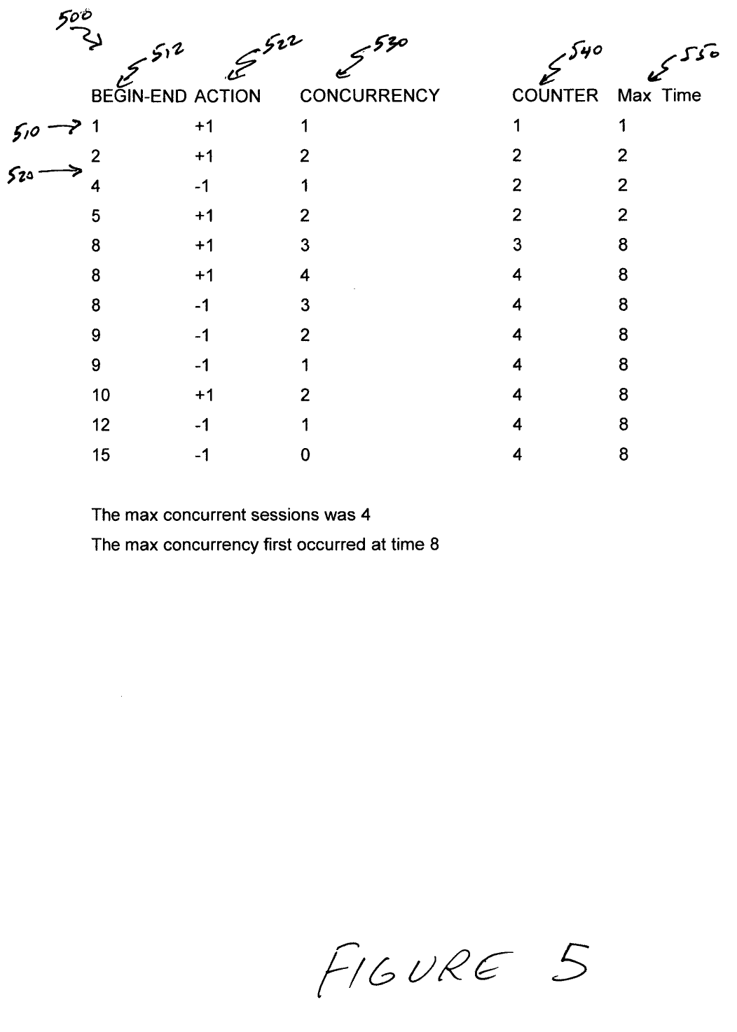

To simplify an understanding of the method of traversing a data set 400 discussed herein, the method of traversing a data set 400 is discussed in conjunction with elements from FIG. 5.

The method of traversing a data set 400 of event records begins with step 410 that initializes pointers and counters. In particular, a BEGIN-list-pointer 510 is set to point to a first element in a BEGIN-list 512. An END-list-pointer 520 is set to point to just before or prior to a first time in a concurrency list 522. A concurrency-counter 530, a max-concurrency-counter 540, and a max-concurrency-time 540 are all set to zero.

In step 420, the BEGIN-list 512 is traversed. The concurrency-counter 530 is incremented and the BEGIN-list-pointer 510 is advanced until step 440 determines that a BEGIN-list-pointer time<=an END-list-pointer time. Every time the concurrency-counter 530 is incremented, the max-concurrency counter 540 is compared concurrency counter 530.

If step 440 determines that a BEGIN-list-pointer time<=an END-list-pointer time, the method of traversing a data set 400 branches to step 470.

If step 450 determines that the concurrency-counter 530 is larger than the max-concurrency counter 540, the max-concurrency-counter 540 is set to the concurrency-counter value 530 and the max-concurrency-time 550 is set to the time value of the BEGIN-list-pointer 510.

The END-list is traversed in step 470, decrementing the concurrency-counter 530 and advancing the END-list-pointer 520 until an END-list-pointer-time time<a BEGIN-list-pointer time. If step 490 determines that an END-list-pointer-time time<a BEGIN-list-pointer time, step 490 branches to step 420 to switch back to traversing the BEGIN-list 512 starting at the BEGIN-list-pointer 510. The method of traversing a data set 400 repeats between the BEGIN-list and the END-list until one of the lists has been fully traversed (i.e one of the pointers reaches the end of its list). Steps 430 and 490 continuously determine if method of traversing a data set 400 has reached an end of the BEGIN-list and the END-list.

FIG. 5 shows exemplary numerical results produced by traversing the event records shown in FIG. 3, in accordance with the principles of the present invention.

Shown are the BEGIN-list-pointer 510 and the END-list pointer 520 at a time of initialization. BEGIN-list-pointer 510 is set to point to a first element in a BEGIN-list 512. An END-list-pointer 520 is set to point to just before a first element in an END-list. In this example, the BEGIN-list pointer 510 points to BEGIN time “1” and the END-list pointer 520 points to just before the END time “4”.

Column 512 shows the BEGIN-END times from FIG. 2a listed in ascending order.

Column 522 depicts a concurrency determination as a result of pointer 510 moving down column 512. Moving pointer 510 down a list of BEGIN times results in an increment of a current value from column 530, depicted as “+1”. Moving pointer 520 down a list of END times results in a decrement of a current value from column 530, depicted as “−1”.

Column 530 depicts a concurrency determination as a result of an incrementing in either a list of BEGIN times or an increment in a list of END times. Column 530 is incremented if pointer 510 is incremented. Otherwise, column 530 is decremented if pointer 520 is incremented.

Column 540 lists the maximum number of events or sessions yet seen for any given BEGIN-END time. For the example shown in FIG. 2a, the maximum concurrent events or sessions that occur is four.

Column 550 lists the maximum number of concurrencies that occur during a particular time that spans from “1” and “15”. For the example of the time periods shown in FIG. 2a, the maximum concurrent events or sessions occur at a common earliest time of “8”.

Thus, in accordance with the principles of the present invention, increasing the number of events linearly increases the length of time needed to calculate the maximum number of concurrent sessions and the maximum concurrency time for those maximum number of concurrent sessions.

An exemplary Procedural Language (PL)/Structured Query Language (SQL) routine for implementing the flowchart shown in FIG. 5 is as follows:

```
CREATE OR REPLACE function maxConcurrent
return varchar
is
  myStart number(13);
  myEnd number(13);
  theCount  number(3) := 0;
  maxCount number(3) := 0;
  output varchar(8000);
  cursor start_cur is
  select creationDate
  from foo
  order by creationDate asc;
  cursor end_cur is
  select endTime
  from foo
  order by endTime asc;
begin
open start_cur;
open end_cur;
fetch start_cur into myStart;
fetch end_cur into myEnd;
loop
exit when start_cur%NOTFOUND or end_cur%NOTFOUND;
    if (myStart <= myEnd) then
      theCount := theCount + 1;
          if (theCount > maxCount) then
            maxCount := theCount;
                output := maxCount||‘ (‘||myStart||’ to ‘||myEnd||’ )’
          elsif (theCount = maxCount) then
            -- handle subsequent periods with same max value here
          end if;
      fetch start_cur into myStart;
    else
      theCount := theCount −1;
      fetch end_cur into myEnd;
    end if;
end loop;
close start_cur;
close end_cur;
return output;
end;
/
```

Although an exemplary PL/SQL routine for implementing the flowchart shown in FIG. 4 is shown above, a routine for implementing the flowchart shown in FIG. 4 can be implemented in any of a number of programming languages including C++, Visual Basic, FORTRAN, Pascal, COCOL, Ada, etc.

The present invention permits the ability to calculate more efficiently translates to a need for less hardware or cheaper hardware. Moreover, the invention permits the ability to scale linearly translates to an ability to handle any data set, no matter the size, with a predictable set of hardware.

The invention has particular applicability to software developers, and professional database companies.

While the invention has been described with reference to the exemplary embodiments thereof, those skilled in the art will be able to make various modifications to the described embodiments of the invention without departing from the true spirit and scope of the invention.

What is claimed is:

1. A method of calculating concurrent events associated with telephone devices, comprising
accessing a physical event records database to retrieve a plurality of event records associated with a plurality of telephone devices;
setting at least one pointer to a beginning of a list of said plurality of event records; and
moving said at least one pointer down said list of said plurality of event records to determine a maximum number of concurrent events.

2. The method of calculating concurrent events associated with telephone devices according to claim 1, further comprising:
setting a BEGIN-list pointer to point to an event time associated with an earliest BEGIN-time from said list of said plurality of event records associated with said plurality of telephone devices.

3. The method of calculating concurrent events associated with telephone devices according to claim 1, further comprising:
setting an END-list pointer to point to just prior to an event time associated with an earliest end time from said list of said plurality of event records associated with said plurality of telephone device.

4. The method of calculating concurrent events associated with telephone devices according to claim 1, wherein:
said telephone device is a fax machine.

5. The method of calculating concurrent events associated with telephone devices according to claim 1, wherein:
said telephone device is a cellular telephone.

6. The method of calculating concurrent events associated with telephone devices according to claim 1, wherein said plurality of event records comprise:
pre-sorted BEGIN-times.

7. The method of calculating concurrent events associated with telephone devices according to claim 1, wherein said plurality of event records comprise:
pre-sorted END-times.

9. The method of calculating concurrent events associated with telephone devices according to claim 1, further comprising:
calculating an earliest time at which said maximum concurrent events begin.

10. The method of calculating concurrent events associated with telephone devices according to claim 1, wherein:
at least one of said plurality of event records is a Voice over Internet Protocol (VoIP) call.

11. The method of calculating concurrent events associated with telephone devices according to claim 1, wherein:
at least one of said plurality of event records is an Internet session.
